(19) United States
(12) Patent Application Publication
(10) Pub. No.: US 2012/0197969 A1
(43) Pub. Date: Aug. 2, 2012

(54) METHODS AND SYSTEMS FOR MANAGING CHAT-ROOM COMMUNICATIONS

(75) Inventor: TAI CHEUNG POON, Hong Kong (HK)

(73) Assignee: CHATROOM RESTRICTION LIMITED, Hong Kong (HK)

(21) Appl. No.: 13/015,939

(22) Filed: Jan. 28, 2011

(51) Int. Cl. G06F 15/16

(52) U.S. Cl. 709/203

(57) ABSTRACT

Systems and methods for managing chat-room communications are provided. In one embodiment, a centralized chat-room management system for handling instant messages is provided. Further in the embodiment, a chat-room and a queue in the chat-room is included. The chat-room places chat messages into the queue after receiving the messages from users joining the chat-room and queues up the chat messages before sending to other users. Moreover, in the embodiment, a later queue is included in the chat-room, wherein the chat-room sends the chat messages to the other users at a later time, according to schedules provided in the messages.

### FIELD OF THE INVENTION

This invention generally relates to a system for managing chat-room communications. This invention specifically relates to, but not limited to, receiving chat-room messages from mobile device, wherein each of the messages includes time-stamp, which specifies a time in local format, the time expected to be sent as part of content information to the other users, in order to provide clarity with respect to delivery time of the message sent by the users.

### BACKGROUND OF THE INVENTION

Viewed by many as the most prominent tools in the technology worlds, online chat-room has provided a very popular means for people to communicate in the information technology world. A chat-room allows multiple parties to chat in a closed environment through different computing clients. To begin with, chat-room communications first emerged as a tool based on accessing the Internet using computer desktops, which are fixed in offices or at home. With the emergence of increasing popularity of mobile communications, Internet access using mobile devices has becoming more prevalent. Applications, such as chat rooms, have also been migrated to the wireless space. Chatting through the wireless phones or other wireless devices can provide Internet users immediate chatting opportunities with other users. With the new tool, real time communications can be realized at anytime, at anywhere, by virtually anyone.

Regardless using wired or wireless communications, chat rooms access penetrate users in all of our daily lives. When one user sends a message to the chat-room, all the other parties in the chat-room can see the message. Without any restrictions, other users in the chat-room may participate and in turn responses or start another conversation by sending another message to the chat-room. Chat messages can be freely be sent by any users in the chat-room. As such, messages shown in one user's screen can come from many users but not just one dedicated user. Therefore, a message from one user is usually accompanied with the user's name or nickname, plus any other relevant information, such as the message's date and time of which the message is sent. Some of this information can be very helpful, even days or hours after the chat. For example, some of such information can serve as evidence for certain purposes, such as investigation of a crime. In the example, an investigation officer may want to search for some evidentiary information from the chat. The investigation officer may want to formulate a logical consequence of certain events from the messages in a chat. Thus, the exact time of when the message was sent and any time quoted in the message should be ideally provided. Currently, and to some extent unfortunately, only the local time is provided. The time is either provided by the chat room server or the chat room client—i.e. the user who receives the message. There is no way that the receiving party knows where the message was sent and what time zone the message was sent. This creates problems as Internet is without boundary and does not limit sending chat messages from the same area or time zone. More likely, during a chat, users expressing opinions may join in randomly. Thus, these users may come from different country and different time zones. Currently, therefore, tracing chat information can become very difficult, especially for end clients.

In view of the foregoing, there is a need for obtaining accurate information with respect to the messages received by different users of the chat room. There is also a need for end clients to trace messages and determine the order sequence of sending the messages, based on when and where the chat messages are sent.

### SUMMARY OF THE INVENTION

In accordance with an embodiment of the prevent invention, a system for managing chat-room communications is provided. The system comprises a centralized chat-room management system (ccms) for handling instant messages. The system institutes a plurality of virtual chat-rooms. In the embodiment, a chat-room is included in the centralized chat-room management system. Likewise, an queue is included in the chat-room, wherein the chat-room places chat messages into the queue after receiving the messages from users joining the chat-room and queues up the chat messages before sending to other users. Further, a later queue is included in the chat-room, wherein the chat-room sends the chat messages to the other users at a later time, according to schedules provided in the messages. Moreover, the inventive system includes a mobile device of a first user; a queue included in the mobile device of the first user, wherein the mobile device of the first user places chat messages into the queue after receiving the messages from the chat-room; a mobile device of a second user; a queue included in the mobile device of the second user, wherein the mobile device of the second user places chat messages into the queue after receiving the messages from the chat-room; a mobile device of a third user; a queue included in the mobile device of the third user, wherein the mobile device of the second user places chat messages into the queue after receiving the messages from the chat-room; a processor in the ccms; and a memory in the ccms, wherein the memory storing instructions that cause the processor to execute a method.

In one aspect of the embodiment, the method may comprise receiving a chat-room message from the mobile device of the first user, wherein the message includes a planned scheduled-time, wherein the planned scheduled-time specifies a time in local format, which requires the message to be sent to the other users at the later time, in accordance of the planned scheduled-time; placing the chat-room message into the queue; moving the chat-room message into the later queue, after detecting that the chat-room message contains the planned scheduled-time; prompting for a location from the location detection device included in the mobile device of the first user, after detecting that the scheduled-time in the chat-room message contains the time only in local format, without providing information with respect to time zones; receiving the location from the mobile device of the first user, after the mobile device detects the location from the location detection device included in the mobile device; determining a time zone of the scheduled time in the chat-room message, based on the location received from the mobile device of the first user; determining an exact date and time of the scheduled-time of sending the chat-room message, based on the time in local format and the time zone of the scheduled time in the chat-room message; and removing the chat-room message from the later queue, at the exact date and time, and sending the message to the other users of the chat-room, including the queue included in the mobile device of the second user and the queue included in the mobile device of the third user.

In a different aspect of the embodiment, the method may include receiving a chat-room message from the mobile device of the first user, wherein the message includes a time-stamp, wherein the time-stamp specifies a time in local format, the time expected to be sent as part of content information to the other users, in order to provide clarity with respect to delivery time of the message sent by the first user; placing the chat-room message into the queue; prompting for a location from the location detection device included in the mobile device of the first user, after detecting that the time-stamp in the chat-room message is in local format only, without providing information with respect to time zones; receiving the location from the mobile device of the first user, after the mobile device detects the location from the location detection device included in the mobile device; determining a time zone of the time-stamp in the chat-room message, based on the location received from the mobile device of the first user; determining an exact date and time of the time-stamp of sending the chat-room message, based on the time-stamp in local format and the time zone; and sending the message to the other users of the chat-room, including the queue included in the mobile device of the second user and the queue included in the mobile device of the third user.

In accordance with another embodiment, the method may include receiving a chat-room message from the mobile device of the first user, wherein the message includes a time-stamp, wherein the time-stamp specifies a time in local format, the time expected to be sent as part of content information to the other users, in order to provide clarity with respect to delivery time of the message sent by the first user; placing the chat-room message into the queue; prompting for a location from the location detection device included in the mobile device of the first user, after detecting that the time-stamp in the chat-room message is in local format only, without providing information with respect to time zones; receiving the location from the mobile device of the first user, after the mobile device detects the location from the location detection device included in the mobile device; determining a time zone of the time-stamp in the chat-room message, based on the location received from the mobile device of the first user; determining an exact date and time of the time-stamp of sending the chat-room message, based on the time-stamp in local format and the time zone; sending the message including the determined exact date and time of the time-stamp to the other users of the chat-room, via, including, the queue included in the mobile device of the second user and the queue included in the mobile device of the third user; and displaying, by each mobile device of each user, the message and the time-stamp.

In yet another embodiment, the method may comprise receiving a chat-room message from the mobile device of the first user, wherein the message includes a time-stamp, wherein the time-stamp specifies a time in local format, the time expected to be sent as part of content information to the other users, in order to provide clarity with respect to delivery time of the message sent by the first user; placing the chat-room message into the queue; prompting for a location from the location detection device included in the mobile device of the first user, after detecting that the time-stamp in the chat-room message is in local format only, without providing information with respect to time zones; receiving the location from the mobile device of the first user, after the mobile device detects the location from the location detection device included in the mobile device; determining a time zone of the time-stamp in the chat-room message, based on the location received from the mobile device of the first user; determining an exact date and time of the time-stamp of sending the chat-room message, based on the time-stamp in local format and the time zone; sending the message including the determined exact date and time of the time-stamp to the other users of the chat-room, via, including, the queue included in the mobile device of the second user and the queue included in the mobile device of the third user; and displaying, by each mobile device of each user, the message and the time-stamp, in view of the determined exact date and time of the time-stamp and a location detected by each location detection device included in each mobile device.

According to another aspect of the invention, the method may include receiving a chat-room message from the mobile device of the first user, wherein the message includes a time-stamp, wherein the time-stamp specifies a time in local format, the time expected to be sent as part of content information to the other users, in order to provide clarity with respect to delivery time of the message sent by the first user; placing the chat-room message into the queue; blocking the message from sending to other users, after detecting that the time-stamp in the chat-room message is in local format only, without providing information with respect to time zones, until receiving a confirmation from the first user that includes a location from the location detection device included in the mobile device of the first user; receiving the location from the mobile device of the first user, after the mobile device detects the location from the location detection device included in the mobile device; determining a time zone of the time-stamp in the chat-room message, based on the location received from the mobile device of the first user; determining an exact date and time of the time-stamp of sending the chat-room message, based on the time-stamp in local format and the time zone; sending the message including the determined exact date and time of the time-stamp to the other users of the chat-room, via, including, the queue included in the mobile device of the second user and the queue included in the mobile device of the third user; and displaying, by each mobile device of each user, the message and the time-stamp, in view of the determined exact date and time of the time-stamp and a location detected by each location detection device included in each mobile device.

### BRIEF DESCRIPTION OF THE DRAWINGS

FIG. 1 illustrates an exemplary system for managing chat-room communications.

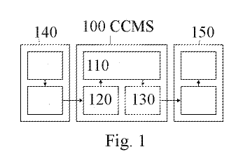

### DETAILED DESCRIPTION

System and methods are provided for managing chat-room communications. In one implementation, a system is provided. The system may comprises a centralized chat-room management system (ccms) for handling instant messages, the system institutes a plurality of virtual chat-rooms; a chat-room (110) included in the centralized chat-room management system; a queue (120) included in the chat-room, wherein the chat-room (110) places chat messages into the queue (120) after receiving the messages from users joining the chat-room (110) and queues up the chat messages before sending to other users; a later queue (130) included in the chat-room.

A chat-room (110) may send the chat messages to the other users at a later time, according to schedules provided in the messages; a mobile device of a first user (140); a queue included in the mobile device of the first user, wherein the mobile device of the first user places chat messages into the queue after receiving the messages from the chat-room; a mobile device of a second user (150); a queue included in the mobile device of the second user, wherein the mobile device of the second user places chat messages into the queue after receiving the messages from the chat-room; a mobile device of a third user; a queue included in the mobile device of the third user.

The mobile device of the second user may place chat messages into the queue after receiving the messages from the chat-room; a processor in the ccms; a memory in the ccms, wherein the memory storing instructions that cause the processor to execute a method, the method comprising receiving a chat-room message from the mobile device of the first user, wherein the message includes a planned scheduled-time, wherein the planned scheduled-time specifies a time in local format, which requires the message to be sent to the other users at the later time, in accordance of the planned scheduled-time; placing the chat-room message into the queue; moving the chat-room message into the later queue (130), after detecting that the chat-room message contains the planned scheduled-time; prompting for a location from the location detection device included in the mobile device of the first user, after detecting that the scheduled-time in the chat-room message contains the time only in local format, without providing information with respect to time zones; receiving the location from the mobile device of the first user, after the mobile device detects the location from the location detection device included in the mobile device; determining a time zone of the scheduled time in the chat-room message, based on the location received from the mobile device of the first user; determining an exact date and time of the scheduled-time of sending the chat-room message, based on the time in local format and the time zone of the scheduled time in the chat-room message; and removing the chat-room message from the later queue (130), at the exact date and time, and sending the message to the other users of the chat-room, including the queue included in the mobile device of the second user and the queue included in the mobile device of the third user.

In a different implementation, a system may be provided for managing chat-room communications. The system includes a centralized chat-room management system (ccms) (100) for handling instant messages, the system institutes a plurality of virtual chat-rooms; chat-room (110) included in the centralized chat-room management system; a queue included in the chat-room (120), wherein the chat-room (110) places chat messages into the queue after receiving the messages from users joining the chat-room (110) and queues up the chat messages before sending to other users; later queue (130) included in the chat-room, wherein the chat-room (110) sends the chat messages to the other users at a later time, according to schedules provided in the messages; mobile device of a first user; queue included in the mobile device of the first user, wherein the mobile device of the first user places chat messages into the queue after receiving the messages from the chat-room; mobile device of a second user (150); queue included in the mobile device of the second user, wherein the mobile device of the second user places chat messages into the queue after receiving the messages from the chat-room; mobile device of a third user; a queue included in the mobile device of the third user, wherein the mobile device of the second user places chat messages into the queue after receiving the messages from the chat-room; a processor in the ccms; a memory in the ccms, wherein the memory storing instructions that cause the processor to execute a method, the method comprising receiving a chat-room message from the mobile device of the first user, wherein the message includes a time-stamp, wherein the time-stamp specifies a time in local format, the time expected to be sent as part of content information to the other users, in order to provide clarity with respect to delivery time of the message sent by the first user; placing the chat-room message into the queue; prompting for a location from the location detection device included in the mobile device of the first user, after detecting that the time-stamp in the chat-room message is in local format only, without providing information with respect to time zones; receiving the location from the mobile device of the first user, after the mobile device detects the location from the location detection device included in the mobile device; determining a time zone of the time-stamp in the chat-room message, based on the location received from the mobile device of the first user; determining an exact date and time of the time-stamp of sending the chat-room message, based on the time-stamp in local format and the time zone; and sending the message to the other users of the chat-room, including the queue included in the mobile device of the second user and the queue included in the mobile device of the third user.

In yet another implementation, the system may be configured to receiving a chat-room message from the mobile device of the first user, wherein the message includes a time-stamp, wherein the time-stamp specifies a time in local format, the time expected to be sent as part of content information to the other users, in order to provide clarity with respect to delivery time of the message sent by the first user; placing the chat-room message into the queue; prompting for a location from the location detection device included in the mobile device of the first user, after detecting that the time-stamp in the chat-room message is in local format only, without providing information with respect to time zones; receiving the location from the mobile device of the first user, after the mobile device detects the location from the location detection device included in the mobile device; determining a time zone of the time-stamp in the chat-room message, based on the location received from the mobile device of the first user; determining an exact date and time of the time-stamp of sending the chat-room message, based on the time-stamp in local format and the time zone; sending the message including the determined exact date and time of the time-stamp to the other users of the chat-room, via, including, the queue included in the mobile device of the second user and the queue included in the mobile device of the third user; and displaying, by each mobile device of each user, the message and the time-stamp.

In yet another embodiment, an inventive system may be configured to support receiving a chat-room message from the mobile device of the first user, wherein the message includes a time-stamp, wherein the time-stamp specifies a time in local format, the time expected to be sent as part of content information to the other users, in order to provide clarity with respect to delivery time of the message sent by the first user; placing the chat-room message into the queue; prompting for a location from the location detection device included in the mobile device of the first user, after detecting that the time-stamp in the chat-room message is in local format only, without providing information with respect to time zones; receiving the location from the mobile device of the first user, after the mobile device detects the location from the location detection device included in the mobile device; determining a time zone of the time-stamp in the chat-room message, based on the location received from the mobile device of the first user; determining an exact date and time of the time-stamp of sending the chat-room message, based on the time-stamp in local format and the time zone; sending the message including the determined exact date and time of the time-stamp to the other users of the chat-room, via, including, the queue included in the mobile device of the second user and the queue included in the mobile device of the third user; and displaying, by each mobile device of each user, the message and the time-stamp, in view of the determined exact date and time of the time-stamp and a location detected by each location detection device included in each mobile device.

Other examples may be provided. For instance, a system is provided for managing chat-room communications, comprising a centralized chat-room management system (ccms) (100) for handling instant messages, the system institutes a plurality of virtual chat-rooms; a chat-room (110) included in the centralized chat-room management system; an queue included in the chat-room (120), wherein the chat-room (110) places chat messages into the queue after receiving the messages from users joining the chat-room (110) and queues up the chat messages before sending to other users; a later queue (130) included in the chat-room, wherein the chat-room (110) sends the chat messages to the other users at a later time, according to schedules provided in the messages; a mobile device of a first user (140); a queue included in the mobile device of the first user, wherein the mobile device of the first user places chat messages into the queue after receiving the messages from the chat-room; a mobile device of a second user (150); a queue included in the mobile device of the second user, wherein the mobile device of the second user places chat messages into the queue after receiving the messages from the chat-room; a mobile device of a third user; a queue included in the mobile device of the third user, wherein the mobile device of the second user places chat messages into the queue after receiving the messages from the chat-room; a processor in the ccms; a memory in the ccms, wherein the memory storing instructions that cause the processor to execute a method, the method comprising receiving a chat-room message from the mobile device of the first user, wherein the message includes a time-stamp, wherein the time-stamp specifies a time in local format, the time expected to be sent as part of content information to the other users, in order to provide clarity with respect to delivery time of the message sent by the first user; placing the chat-room message into the queue; blocking the message from sending to other users, after detecting that the time-stamp in the chat-room message is in local format only, without providing information with respect to time zones, until receiving a confirmation from the first user that includes a location from the location detection device included in the mobile device of the first user; receiving the location from the mobile device of the first user, after the mobile device detects the location from the location detection device included in the mobile device; determining a time zone of the time-stamp in the chat-room message, based on the location received from the mobile device of the first user; determining an exact date and time of the time-stamp of sending the chat-room message, based on the time-stamp in local format and the time zone; sending the message including the determined exact date and time of the time-stamp to the other users of the chat-room, via, including, the queue included in the mobile device of the second user and the queue included in the mobile device of the third user; and displaying, by each mobile device of each user, the message and the time-stamp, in view of the determined exact date and time of the time-stamp and a location detected by each location detection device included in each mobile device.

While the invention has been shown and described with reference to particular embodiments thereof, it will be understood by those skilled in the art that the invention can be practiced, with modification, in other environments. For example, although the invention described above can be conveniently implemented in a general purpose computer selectively reconfigured or activated by software, those skilled in the art would recognize that the invention could be carried out in hardware, in firmware or in any combination of software, firmware or hardware including a special purpose apparatus specifically designed to perform the described invention. Therefore, changes in form and detail may be made therein without departing from the spirit and scope of the invention as set forth in the accompanying claims.

What is claimed is:

1. A system for managing chat-room communications, comprising:
a centralized chat-room management system (ccms) for handling instant messages, the system institutes a plurality of virtual chat-rooms;
a chat-room included in the centralized chat-room management system;
an queue included in the chat-room, wherein the chat-room places chat messages into the queue after receiving the messages from users joining the chat-room and queues up the chat messages before sending to other users;
a later queue included in the chat-room, wherein the chat-room sends the chat messages to the other users at a later time, according to schedules provided in the messages;
a mobile device of a first user;
a queue included in the mobile device of the first user, wherein the mobile device of the first user places chat messages into the queue after receiving the messages from the chat-room;
a mobile device of a second user;
a queue included in the mobile device of the second user, wherein the mobile device of the second user places chat messages into the queue after receiving the messages from the chat-room;
a mobile device of a third user;
a queue included in the mobile device of the third user, wherein the mobile device of the second user places chat messages into the queue after receiving the messages from the chat-room;
a processor in the ccms;
a memory in the ccms, wherein the memory storing instructions that cause the processor to execute a method.

2. The system of claim 1, wherein the method comprises:
receiving a chat-room message from the mobile device of the first user, wherein the message includes a planned scheduled-time, wherein the planned scheduled-time specifies a time in local format, which requires the message to be sent to the other users at the later time, in accordance of the planned scheduled-time;
placing the chat-room message into the queue;
moving the chat-room message into the later queue, after detecting that the chat-room message contains the planned scheduled-time;
prompting for a location from the location detection device included in the mobile device of the first user, after detecting that the scheduled-time in the chat-room message contains the time only in local format, without providing information with respect to time zones;
receiving the location from the mobile device of the first user, after the mobile device detects the location from the location detection device included in the mobile device;
determining a time zone of the scheduled time in the chat-room message, based on the location received from the mobile device of the first user;
determining an exact date and time of the scheduled-time of sending the chat-room message, based on the time in local format and the time zone of the scheduled time in the chat-room message; and
removing the chat-room message from the later queue, at the exact date and time, and sending the message to the other users of the chat-room, including the queue included in the mobile device of the second user and the queue included in the mobile device of the third user.

3. The system of claim 1, wherein the method further comprises:
receiving a chat-room message from the mobile device of the first user, wherein the message includes a time-stamp, wherein the time-stamp specifies a time in local format, the time expected to be sent as part of content information to the other users, in order to provide clarity with respect to delivery time of the message sent by the first user;
placing the chat-room message into the queue;
prompting for a location from the location detection device included in the mobile device of the first user, after detecting that the time-stamp in the chat-room message is in local format only, without providing information with respect to time zones;
receiving the location from the mobile device of the first user, after the mobile device detects the location from the location detection device included in the mobile device;
determining a time zone of the time-stamp in the chat-room message, based on the location received from the mobile device of the first user;
determining an exact date and time of the time-stamp of sending the chat-room message, based on the time-stamp in local format and the time zone; and
sending the message to the other users of the chat-room, including the queue included in the mobile device of the second user and the queue included in the mobile device of the third user.

4. The system of claim 1, wherein the method further comprises:
receiving a chat-room message from the mobile device of the first user, wherein the message includes a time-stamp, wherein the time-stamp specifies a time in local format, the time expected to be sent as part of content information to the other users, in order to provide clarity with respect to delivery time of the message sent by the first user;
placing the chat-room message into the queue;
prompting for a location from the location detection device included in the mobile device of the first user, after detecting that the time-stamp in the chat-room message is in local format only, without providing information with respect to time zones;
receiving the location from the mobile device of the first user, after the mobile device detects the location from the location detection device included in the mobile device;
determining a time zone of the time-stamp in the chat-room message, based on the location received from the mobile device of the first user;
determining an exact date and time of the time-stamp of sending the chat-room message, based on the time-stamp in local format and the time zone;
sending the message including the determined exact date and time of the time-stamp to the other users of the chat-room, via, including, the queue included in the mobile device of the second user and the queue included in the mobile device of the third user; and
displaying, by each mobile device of each user, the message and the time-stamp.

5. The system of claim 1, wherein the method further comprises:
receiving a chat-room message from the mobile device of the first user, wherein the message includes a time-stamp, wherein the time-stamp specifies a time in local format, the time expected to be sent as part of content information to the other users, in order to provide clarity with respect to delivery time of the message sent by the first user;
placing the chat-room message into the queue;
prompting for a location from the location detection device included in the mobile device of the first user, after detecting that the time-stamp in the chat-room message is in local format only, without providing information with respect to time zones;
receiving the location from the mobile device of the first user, after the mobile device detects the location from the location detection device included in the mobile device;
determining a time zone of the time-stamp in the chat-room message, based on the location received from the mobile device of the first user;
determining an exact date and time of the time-stamp of sending the chat-room message, based on the time-stamp in local format and the time zone;
sending the message including the determined exact date and time of the time-stamp to the other users of the chat-room, via, including, the queue included in the mobile device of the second user and the queue included in the mobile device of the third user; and
displaying, by each mobile device of each user, the message and the time-stamp, in view of the determined exact date and time of the time-stamp and a location detected by each location detection device included in each mobile device.

6. The system of claim 1, wherein the method further comprises:
receiving a chat-room message from the mobile device of the first user, wherein the message includes a time-stamp, wherein the time-stamp specifies a time in local format, the time expected to be sent as part of content information to the other users, in order to provide clarity with respect to delivery time of the message sent by the first user;
placing the chat-room message into the queue;
blocking the message from sending to other users, after detecting that the time-stamp in the chat-room message is in local format only, without providing information with respect to time zones, until receiving a confirmation from the first user that includes a location from the location detection device included in the mobile device of the first user;
receiving the location from the mobile device of the first user, after the mobile device detects the location from the location detection device included in the mobile device;
determining a time zone of the time-stamp in the chat-room message, based on the location received from the mobile device of the first user;
determining an exact date and time of the time-stamp of sending the chat-room message, based on the time-stamp in local format and the time zone;
sending the message including the determined exact date and time of the time-stamp to the other users of the chat-room, via, including, the queue included in the mobile device of the second user and the queue included in the mobile device of the third user; and
displaying, by each mobile device of each user, the message and the time-stamp, in view of the determined exact date and time of the time-stamp and a location detected by each location detection device included in each mobile device.
